(19) United States
(12) Patent Application Publication
(10) Pub. No.: US 2007/0266114 A1
(43) Pub. Date: Nov. 15, 2007

(54) Personal Icon Providing System and Method Thereof

(75) Inventor: Soo-Jung Heo, Seoul (KR)

Correspondence Address: MARGER JOHNSON & MCCOLLOM, P.C., 210 SW MORRISON STREET, SUITE 400, PORTLAND, OR, 97204, US

(73) Assignee: NHN CORPORATION, Kyunggi-do, 463-844 (KR)

(21) Appl. No.: 11/573,198

(22) PCT Filed: Aug. 2, 2005
(86) PCT No.: PCT/KR05/02519

§ 371 Date: Feb. 2, 2007

(30) Foreign Application Priority Data
Aug. 2, 2004 (KR) 2004-0060955

(51) Int. Cl. G06F 15/16

(52) U.S. Cl. 709/217; 709/203

(57) ABSTRACT

Disclosed is a personal icon providing system and method. When a user is accessed through a network, information on personal icons provided to the user is collected. The information on the collected personal icons is transmitted to the user's terminal to be stored therein, and the user's personal icon is displayed on the network by using the information stored in the terminal. In this instance, the personal icon may have a single-layer structure. According to the present invention, the user's icon can be easily displayed at any position on the network, and in particular, a personal icon for identifying the user in cooperation with the user's movement can be quickly and easily provided.

### BACKGROUND OF THE INVENTION

(a) Field of the Invention

The present invention relates to a system and method for providing personal icons. More specifically, the present invention relates to a system and method for providing personal icons to users on a network such as the Internet.

(b) Description of the Related Art

As usage of the Internet has been substantially increased, electronic commerce for people all over the world has been performed through the Internet, communication between users have gradually been developed, and very various types of communications have been executed through the Internet.

Internet telephones as substitutes for cable telephones are now available, in addition to electronic mail and file transmission which are the basic communication forms, and short messages can be transmitted to cellular phones using the Internet. Also, a chat service which is a communication between many users can be performed on the Internet, and a voice chat service or a video chat service is performed through the Internet in addition to the text-based chat service.

Netizens, during the execution of the communication, have been charmed by anonymity in cyber space as they fulfill their desires to express themselves, and avatars are now widely used as means for satisfying the two points. The term “avatar” means an incarnation, and it indicates an animation character that represents the user in cyber space. The avatar has a multi-layer structure allowing facial expressions and gestures. For example, it is possible to present the avatar's facial expressions or motions by dividing the avatar into parts, superimposing them on multiple layers, and sliding the parts on respective layers with different motions.

However, since the avatar has a multi-layer structure and comprises a large volume of data, it is difficult to provide the avatar according to locations of the user on the Internet, and hence, the avatar is generally provided on fixed specific web pages. For example, when a user receives a predetermined avatar from a chat service system, the user can only use the avatar when they have accessed the chat service system, and when the user accesses a second system providing another service, the user cannot use the avatar and must receive another new avatar from the second system.

Also, many users desire to show themselves while posting contents on the bulletin boards or data rooms in the communities such as cafés or blogs, but what is permitted is only to display user IDs or nicknames in the text format since it is not easy to concurrently display avatars of many users because of the avatar's multi-layer structure and large volume of data.

Further, it is difficult to expose the avatar at any location of web pages because of its multi-layer structure and large volume of data.

### SUMMARY OF THE INVENTION

It is an advantage of the present invention to provide a means for identifying a user in cooperation with the user's movement at any location on the Internet. In particular, it is an advantage of the present invention to easily express proper features or sensitivity of individual users at any location on the Internet that provides a plurality of services.

In one aspect of the present invention, in a method for providing a personal icon by using an icon providing server and a service providing server in a system connected to a user terminal through a network, the method includes a) the icon providing server providing personal icons to users according to requests by the users who are accessed through the network, and storing a provided history, b) the service providing server receiving information on the personal icons received by the user from the icon providing server when the user is accessed, c) the service providing server transmitting information on collected personal icons to the user terminal to store the information in the user terminal, and d) the service providing server generating a service page for displaying a personal icon of the user on at least one position by using the information stored in the user terminal and providing the service page.

In another aspect of the present invention, in a method for providing a personal icon by using an icon providing server and a community server connected to a user terminal through a network, the icon providing server storing and controlling information on personal icons provided to users, the method includes a) the community server receiving information on personal icons received by a first user from the icon providing server when the first user is accessed through the network, b) the community server transmitting information on collected personal icons to the first user's terminal to store the information in the first user's terminal, c) the community server displaying the first user's personal icon on the network by using the information stored in the first user terminal, and d) the community server storing results caused by an action of the second user and personal icon information of the second user corresponding to the first user's community when the second user accesses the first user's community through the network and performs a predetermined action.

In still another aspect of the present invention, in a system for providing a personal icon, the system connected to a user terminal through a network, the system includes a provision history database for storing information on personal icons assigned to respective users, an icon collector for collecting information on the personal icons assigned to the user from the database when the user is accessed through the network, an icon transmitter for transmitting information on the collected personal icons to the user terminal to store the information in the user terminal, and an icon display for displaying a personal icon of the user on the network by using the information stored in the terminal.

In still yet another aspect of the present invention, in a service providing server for providing a predetermined service to users accessed through a network, the server being connected to a user terminal and an icon providing server through the network, the service providing server includes a registration database for storing user information, a certifier for performing a log-in process to the user accessed through the network based on the information stored in the registration database, an icon collector for collecting information on the personal icons corresponding to an identification code of the logged-in user from the icon providing server, an icon transmitter for transmitting information on the collected personal icons to the user terminal to store the information in the user terminal, an icon display for displaying a personal icon corresponding to the user's identification code on the network by using the information stored in the terminal, and a service provider for providing services including a service for posting contents of the logged-in user.

In a still further aspect of the present invention, in a method for providing a personal icon by using an icon providing server and a community server wherein the icon providing server connected to a user terminal through a network stores and controls information on the personal icons provided to users, the method includes a) the icon providing server providing personal icons to the user according to requests of users accessed through the network, and storing a provided history, b) the community server receiving information on the personal icons received by the first user from the icon providing server when a first user is accessed through the network, c) the community server transmitting information on the collected personal icons to the first user's terminal and storing the information, d) the community server displaying the first user's personal icon on the network by using the information stored in the first user terminal, e) the community server receiving information on the personal icon assigned to a second user from the icon providing server when the second user accesses the first user's community through the network and performs a predetermined action, and f) the community server storing results caused by an action of the second user and personal icon information of the second user corresponding to the first user's community.

### BRIEF DESCRIPTION OF THE DRAWINGS

The accompanying drawings, which are incorporated in and constitute a part of the specification, illustrate an embodiment of the invention, and, together with the description, serve to explain the principles of the invention.

FIG. 1 shows a block diagram of a personal icon providing system according to an embodiment of the present invention.

FIG. 2 shows a block diagram of an icon providing server shown in FIG. 1.

FIG. 3 shows a set of personal icons according to an embodiment of the present invention.

FIG. 4 shows a configuration of a provision history database according to an embodiment of the present invention.

FIG. 5 shows a detailed configuration of a service providing server shown in FIG. 2.

FIG. 6 shows a flowchart for a personal icon providing process according to an embodiment of the present invention.

FIG. 7 shows an exemplified personal community service page provided to a user according to an embodiment of the present invention.

FIG. 8 shows a personal icon displaying process when a service is used according to an embodiment of the present invention.

FIG. 9 shows an exemplified screen displayed when a user logs in to a first community server according to an embodiment of the present invention.

FIG. 10 shows a flowchart for a personal icon displaying process according to the user's movement according to an embodiment of the present invention.

FIG. 11 shows an exemplified personal icon displayed in the first community according to an embodiment of the present invention.

FIG. 12 shows an exemplified personal icon displayed on the bulletin board according to an embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which the same descriptions are provided have the same reference numerals.

Proper identification means are provided to respective users in the embodiment. In this instance, the proper identification means are cooperated with ID codes (e.g., IDs) assigned to users and a plurality of proper identification means may be assigned to each user. The users may receive the proper identification means according to predefined behaviors such as making a purchase and joining an event.

The user may establish a representative proper identification means from among the proper identification means, and the representative proper identification means selected in cooperation with the user's ID code may be displayed in any case in which the user moves to any location on the Internet. For ease of description, the proper identification means will be referred to as a “personal icon” (or a personacon), and the representative proper identification means will be called a “representative icon” hereinafter.

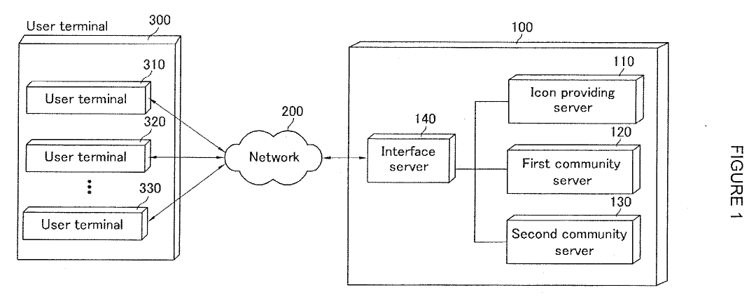

FIG. 1 shows a block diagram of a personal icon providing system according to an embodiment of the present invention.

As shown in FIG. 1, a personal icon providing system 100 is connected to a plurality of user terminals 300 through a network 200 (including all types of networks such as a telephone network, the Internet, and a wireless communication network).

The user terminal 300 is a communication device for accessing the personal icon providing system 100 through the network 200, and includes a cable telephone, a radio communication terminal, a computer, and an Internet TV. Therefore, the user can conveniently and quickly access the personal icon providing system 100 by using PC communication, the Internet, a wireless Internet, or a telephone network.

The personal icon providing system 100 connected to the user terminal 300 and providing personal icons to the users includes an icon providing server 110, and may further include service providing servers 120 and 130 for providing a plurality of services to the users.

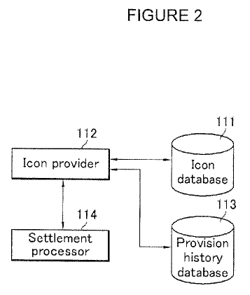

FIG. 2 shows a detailed block diagram of the icon providing server.

As shown therein, the icon providing server 110 for providing personal icons to the users includes an icon database 111 for storing data files (icon files) on the personal icons provided by the system, an icon provider 112 for providing personal icons to the users, and a provision history database 113 for storing information on the personal icons provided for respective users, and further includes a settlement processor 114.

The icon database 111 stores personal icon files corresponding to icon ID codes, and may further store descriptions and generation dates of the corresponding icons. The personal icons may be stored by a plurality of categories.

The personal icon according to the embodiment of the present invention includes at least one “default personal icon,” and may further include at least one “modified personal icon” generated by modifying a component of the default personal icon or adding a new component. Therefore, the default personal icon and the modified personal icon may configure a single set of personal icons. Hence, for example, a single set of personal icons may be stored corresponding to a single icon ID code (a first icon ID code), and an icon ID code (a second icon ID code) can be assigned to the personal icons configuring a single set. In this instance, the first and second icon ID codes are generated to have a correlation between them so that it may be known to which set a personal icon having a predetermined second icon ID code belongs.

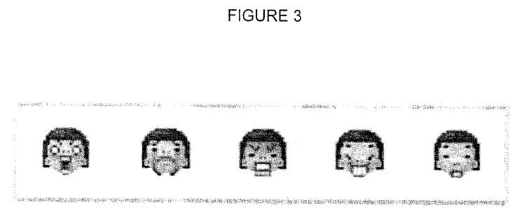

FIG. 3 shows a set of personal icons according to the embodiment of the present invention. The personal icons may have various features including the user's emotion, sex, job, and tendency. For example, as exemplified in FIG. 3, it is possible to configure the personal icon in the human format so as to inform that the corresponding user is a bobbed-haired girl student. However, the personal icon is not limited to the human image and may be any of various images such as animals and things.

The modified personal icon is generated by modifying a component from among a plurality of components that configure a default personal icon, or by adding a plurality of components. For example, as shown in FIG. 3, it is possible to generate modified personal icons b) to e) by modifying components (e.g., lips and eyes) that control facial expression on the default personal icon a) so that the user's emotion or feelings may be displayed. Also, it is possible to express emotion or feelings by modifying colors or shapes of predetermined parts that form the icon as given in c) of FIG. 3.

In addition, the respective personal icons (default personal icon or modified personal icon) may be repeatedly applied to other sets. That is, a personal icon included in the first set can be included in the second set and the third set.

As described, the set of personal icons includes at least one modified personal icon generated by modifying components of the default personal icon together with the default personal icon. The user can receive personal icons for each set thereof, and can also receive the personal icons for each icon.

The icon provider 112 provides the above-noted personal icons to the user, and in particular, it can provide a personal icon to the user according to the user's making a purchase. For this, the icon provider 112 provides personal icons for sale to the users having accessed the system 100, settles an icon or a set of icons selected by the user in cooperation with the settlement processor 114, provides the personal icon or the set of icons to the user when they are settled, and stores a provision history in the provision history database 113. Also, the icon provider 112 can provide a predetermined personal icon to the user who has won an event when the system 100 has performed a predetermined event.

Therefore, the provision history database 113 stores personal icons received by the user according to making a purchase or joining an event corresponding to the user's ID code. For example, the provision history database 113 may store a personal icon file provided to the user corresponding to the user's ID code, or store an icon ID code for the provided personal icon, and in this instance, it may store path information for indicating where the provided personal is stored in the icon database 111.

The user can establish a representative icon from among a plurality of personal icons after having received the personal icons. The representative icon may be selectively established by the user, or the last personal icon used by the user can be automatically established to be a representative icon.

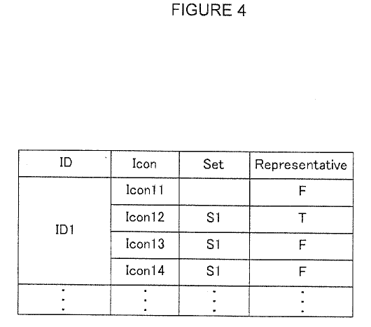

When the representative icon is established, an additional mark can be assigned to the corresponding personal icon stored in the provision history database 113 in correspondence to the user's ID code, or a representative establishment status can be displayed in an additional field. FIG. 4 shows a configuration of a provision history database according to the embodiment of the present invention.

The settlement processor 114 settles for the personal icon bought by the user by using various settlement means (cash, credit card, and cyber money).

The service providing servers 120 and 130 provide personal icons to the users who are accessed in cooperation with the above-configured icon providing server 110, in linkage with the ID code. In this instance, provision of personal icons to the users in linkage with the ID code represents displaying and providing the user's personal icon to all the areas in which the user's ID code is exposed, when the user logs in. For example, when a user posts an article or a reply on the bulletin board in a community such as a café, the user's ID or nickname is displayed. In this instance, the personal icon according to the embodiment of the present invention is controlled to be displayed on the bulletin board together with the article or the reply so that the user's appropriate feature, emotion, or feeling may be expressed.

The service providing servers 120 and 130 will now be exemplified as community servers for providing various community services to users in cooperation with the icon providing server 110 so as to describe a method for providing a personal icon service in linkage with ID codes. The service providing servers are not restricted to the community providing server and may include all servers for providing predefined services to users according to the user's log-in.

In this instance, the community may include any types of communities available on the network, for example, personal communities (blogs, personal homepages, mini homepages, and profiles) that the user manages and in which the user posts contents of documents or opinions, and shared communities (e.g., cafés and clubs) that a plurality of users join as members and communicate documents or opinions on the same subject. Accordingly, the service providing server includes a first community server 120 for providing a personal community service and a second community server 130 for providing a shared community service.

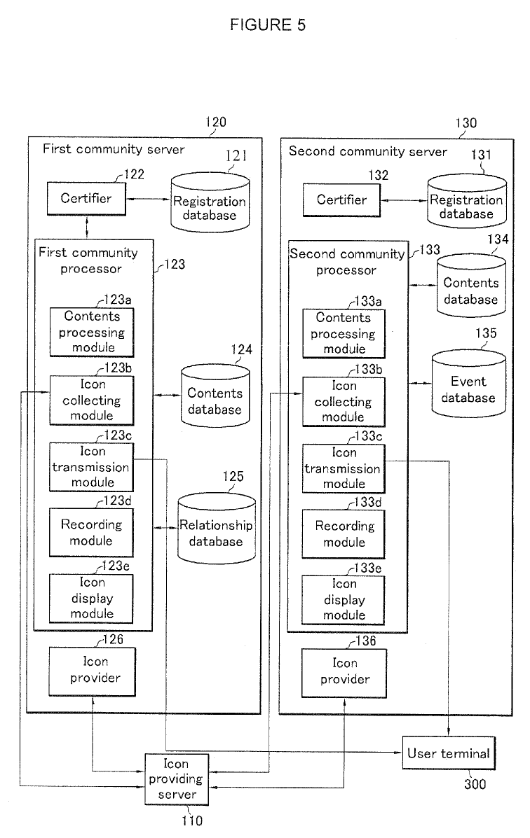

FIG. 5 shows a configuration of the first and second community servers according to the embodiment of the present invention.

The first and second community servers 120 and 130 include registration databases 121 and 131 for storing community-related information for respective registered communities; certifiers 122 and 132 for performing a log-in process; first and second community processors 123 and 133 for configuring communities and performing contents-related actions including posting, providing, modifying, and editing the contents; and contents databases 124 and 134 for storing contents posted for the respective communities.

The first and second community processors 123 and 133 include contents processing modules 123a and 133a for forming communities, registering the communities, posting contents, and managing the contents for the respective communities, and additionally include icon collecting modules 123b and 133b for communicating with the icon providing server 110 and collecting personal icon information on the logged-in user; icon transmitting modules 123c and 133c for transmitting information on all the personal icons received by the corresponding user to the terminal 300 of the logged-in user; recording modules 123d and 133d for storing personal icon information corresponding to the contents generated by the user's contents-related actions; and icon displaying modules 123e and 133e for displaying a predetermined personal icon (e.g., representative icon) on a predetermined location of the community.

The registration databases 121 and 131 stores brief information on the respective registered communities, for example, ID codes of communities registered according to categories, community information including community names corresponding to respective community ID codes, IDs or nicknames of users having generated communities, and registration dates. In the case of shared communities, they may further store information (e.g., IDs) on the users registered as members for respective communities.

The contents databases 124 and 134 store information on the contents provided for the respective communities, and in particular, they store personal icon information together with ID codes of users having provided corresponding contents for the respective contents.

In general, the contents posted in the communities can be sorted according to various categories. For example, in the case of shared communities such as cafés, the contents can be sorted as bulletin boards on which a plurality of users freely posts contents, and replies to the posted contents. Also, in the case of personal communities such as blogs, the contents can be sorted as contents (also referred to as posts) posted by the users who own corresponding communities, comments such as added articles or replies to the posts, and remote replies (referred to as track backs). The contents databases 124 and 134 according to the embodiment of the present invention store contents-related information including contents titles, contents, and contents posted dates for respective categories, user information on who has posted corresponding contents, and the corresponding user's personal icon in addition to an ID which is a general ID code, or a nickname as user information. In this instance, the stored icon may be a representative icon from among the user's personal icons. When the contents are stored as described above, a personal icon may be displayed as user information for the respective contents in the case in which information on a predetermined community is provided on a web page.

In the case of personal communities, another user may visit a predetermined personal community to leave a visit mark or generate an additional relationship. That is, when a second user visits a first user's personal community, the second user can leave a visit mark, and visitors are displayed as items such as “visiting bloggers” in the first user's personal community. Also, the second user can make a relationship of “neighbors” with the first user for the purpose of communication, and when this relationship is generated, second users having the above-noted relationship are displayed with an item of “neighbor blog” on the first user's personal community.

For this, the first community server 120 further includes a relationship database 125 for storing and managing information on the visitors or the users having predetermined relationships. The relationship database 125 stores IDs (or nicknames) of visiting users (in particular, users who desire to be recorded as visitors) for respective personal communities, and their personal icons, and also stores IDs (or nicknames) of users who have predetermined relationships with the respective personal communities, and the users' personal icons. In this instance, the personal icon is the corresponding user's representative icon. It is possible to display the personal icon without any communication with the icon providing server 100 by storing a data file of the personal icon, and without being restricted to this, path information of the personal icon can be stored.

Also, the second community server 13 may further include an event database 125 for storing information on predetermined events executed for the respective shared communities and information on the users who have won the events. In particular, it is possible to display a personal icon together with information on a user who has won the event executed by a shared community to the users who accessed the corresponding shared community, by storing personal icon information on the users who respectively won the events.

The icon providing server 110 mainly performs a function of providing personal icons to the user according to the embodiment of the present invention, and in addition, the first and second community servers 120 and 130 which are service providing servers can perform the function of providing personal icons to the user in cooperation with the icon providing server 110. That is, the user can access the first and second community servers 120 and 130 as well as the icon providing server 110 and receive personal icons according to purchase action. For this, the first and second community servers 120 and 130 may further include icon providers 126 and 136 for providing personal icons to the accessing users in cooperation with the icon providing server 110.

The personal icon providing system 100 may include an interface server 140 for processing users' access to the system in addition to the above-described icon providing server 100 and the first and second community servers 120 and 130. The interface server 140 controls access of a plurality of terminals 300 through the network 200, in particular, the Internet or the wireless Internet, converts various types of information provided through the respective servers 110 to 130 to provide the converted information to the terminals 300, or receives information from a terminal 300 through the network 200 and provides the same to the respective servers 110 to 130, and it may include a database linker (CGI) for information communication with a web server, a WAP server, or another system.

In the embodiment of the present invention, the respective components of the servers 110 to 130 are illustrated to be operable in the corresponding servers, and without being restricted to this, they may be implemented as independent servers to process corresponding functions, and the databases are not restricted to the above-described classification. Also, the icon providing server 110 and the service providing servers 120 and 130 may be realized as individual systems.

A method for providing personal icons according to an embodiment of the present invention will now be described based on the above-noted configuration.

The users can receive a predetermined personal icon from the icon providing server 110 when attempting to present the user with a means other than the ID that is an identification code, and can present the user for usage of various services provided by the service providing server by using the provided personal icon.

For this, the users access the system 100 and receive personal icons.

In order to receive the personal icons, the users must receive predetermined identification codes, that is, IDs, and the users access the icon providing server 110 or the service providing servers 120 and 130 to receive the personal icons.

When the user having received an ID from the system 100 accesses the icon providing server 110 and requests to buy a personal icon, the icon provider 112 of the icon providing server 110 reads information on the personal icons for sale from the icon database 111, generates a product page, and provides it to the user.

When the user selects a predetermined personal icon on the product page and requests to make a purchase, the settlement processor 114 uses settlement means (credit cards, cash, or cyber money) provided by the user to perform settlement on the bought personal icon. In this instance, the user can buy the personal icons by a set of personal icons, or buy them individually. The settlement process is well known to a person skilled in the art, and no detailed description thereof will be provided.

When the settlement process is finished, the icon provider 112 records information on the personal icon bought by the user corresponding to the user's ID in the provision history database 113.

The user accesses the first and second community servers 120 and 130 to log in thereto and then can buy a personal icon as described above.

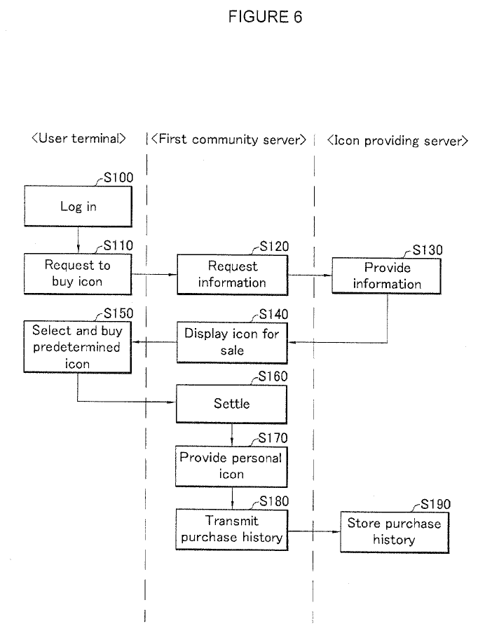

FIG. 6 shows a sequential process for providing a personal icon according to the embodiment of the present invention.

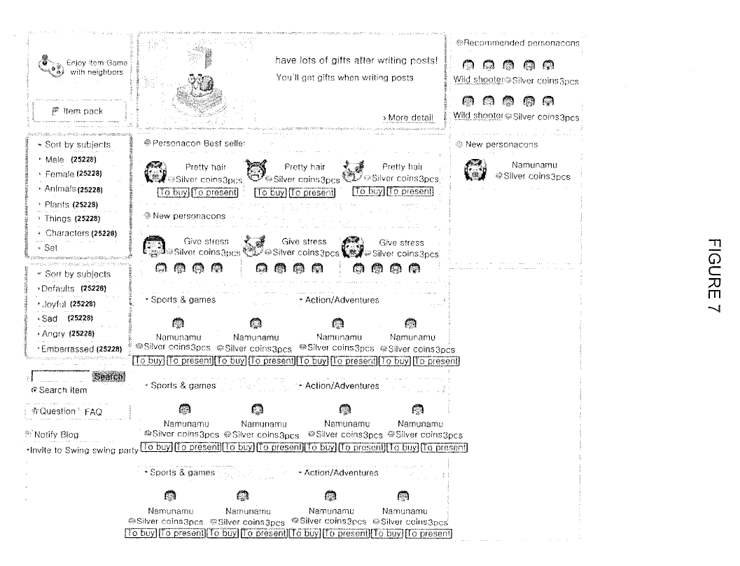

For example, when the user having accessed the first community server 120 requests to buy a personal icon in steps S100 and S110, the icon provider 126 of the first community server 120 takes information on the personal icon for sale from the icon database 111 in cooperation with the icon providing server 110, generates a product page as shown in FIG. 7, and provides the same to the user in steps S120 to S140. FIG. 7 shows an exemplified personal icon product page provided when the users accesses a personal community such as a blog.

When the user selects a predetermined personal icon and requests to make a purchase, the icon provider 126 performs settlement in cooperation with the settlement processor 114 of the icon providing server 110 in steps S150 and S160, and when the settlement is finished, the icon provider 126 provides the user's purchase history (information on the bought personal icon) to the icon providing server 110 to record it in the provision history database 113 in steps S170 to S190. That is, the icon provider 112 of the icon providing server 110 stores information on the personal icon bought corresponding to the user's ID code. In this instance, the information on the personal icon may be a personal icon file, a personal icon ID code, or path information for selectively including an ID code and indicating the position of the corresponding personal icon stored in the icon database 111. The path information is stored therein as icon information corresponding to the user ID in the embodiment of the present invention, and different information may be stored in another embodiment.

A process for displaying a personal icon will now be described when the user uses various services by using the personal icon bought by the user as described above.

Here, exemplified will be the case in which the user accesses a personal community such as a blog and uses a service.

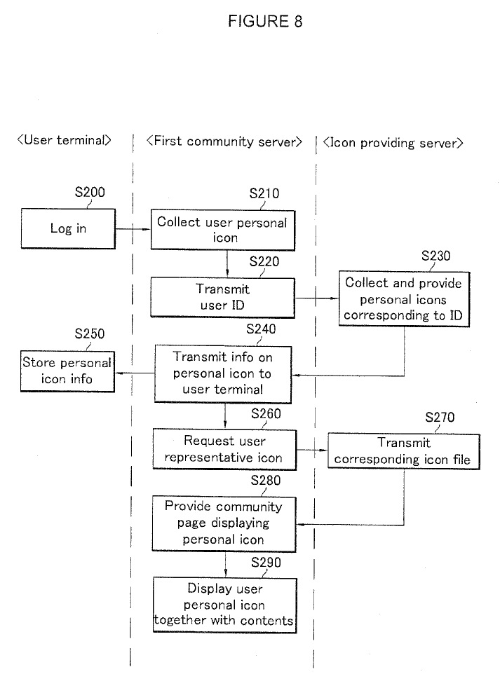

FIG. 8 shows a sequential process for displaying a personal icon in the case of using a service according to an embodiment of the present invention.

When the user accesses the first community server 120, a general log-in process is performed, and when the log-in process is finished, a service page for displaying log-in information on the corresponding user is provided to the user terminal 300. The service page is not a personal community page such as a user's blog, but a page for displaying a plurality of services provided by the first community server. For example, the service page can be information that is initially displayed and shows information on blogs of other users when the user logs in to the blog.

In this instance, the icon collecting module 123b of the first community server 120 communicates with the icon providing server 110 based on the identification code of the logged-in user, that is, the ID thereof, and collects information on the personal icon provided thus far to the user in steps S200 and S210.

In detail, the icon provider 112 of the icon providing server 110 generates path information on the personal icon corresponding to the user ID from the provision history database 113 according to the request by the first community server 120, and provides the path information to the first community server 120 in steps S220 and S230.

The icon transmission module 123c of the first community server 120 transmits information on the provided personal icons to the user terminal 300. That is, the icon transmission module 123c provides path information on the personal icons to the user terminal 300 in step S240 so that the personal icon may be quickly displayed according to the user's moving positions. In the embodiment, path information on the personal icons possessed by the logged-in user is stored in the user terminal 300 in step S250 so that the personal icons may be quickly displayed on the points where the ID is displayed according to the user's activity. For example, the path information is stored in a cookie that is part of a memory area provided in the browser of the user terminal 300. Therefore, the first community server 120 can quickly display the user's personal icon by referring to path information stored in the cookie of the user terminal 300 when needing personal icon information. In this instance, the icon transmission module 123c encodes the path information and transmits the same to the user terminal 300 so as to stabilize information transmission between the first community server 120 and the user terminal 300, and it may decode the path information encoded and stored in the user terminal 300 when needing the information.

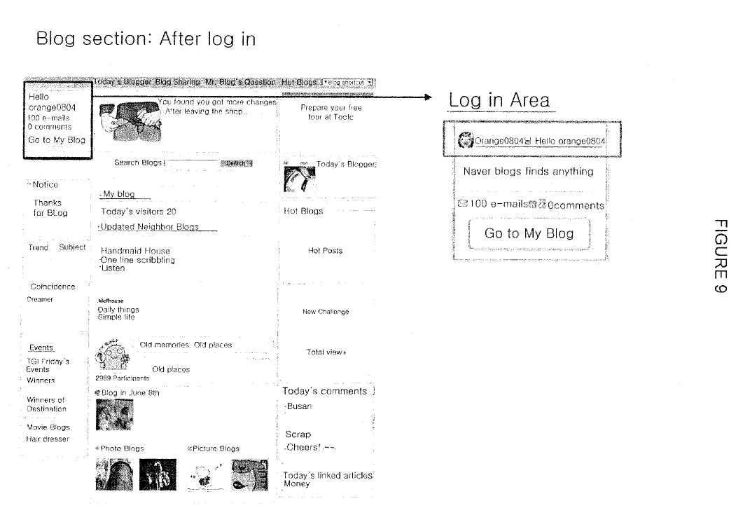

As described above, the first community server 120 accesses a personal community to provide path information on the personal icons of the logged-in users to the user terminal 300, receives a data file that corresponds to a representative icon from among the user's personal icons from the icon database 111 in steps S260 and S270, and displays the corresponding user's personal icon at the point where the logged-in user's ID is displayed in step S280. FIG. 9 shows an exemplified case of displaying a personal icon when the user logs in according to the embodiment.

When the user, having accessed the personal community and having logged in thereto, selects “Go To My Blog”, for example, and moves to the user's personal community, the icon transmission module 123c combines contents registered to the user's personal community to generate the user's personal community initial page, and provides it to the user terminal 300 in step S290. In this instance, the icon transmission module 123c reads predetermined information (information of other users (second users) having performed contents-related actions) including personal icons together with contents-related information stored in the personal community of the user (first user) and generates an initial page in the contents database 124. Therefore, as shown in FIG. 9, contents are displayed for the respective categories, and personal icons of the second users having posted the corresponding contents are displayed. Hence, the user (first user) of the community checks the contents posted in the user's personal community and checks the contents posted by the second users who have visited the user's personal community, and knows what features the second users have and knows the emotion or feelings of the second users that has posted corresponding contents through the personal icons.

A process for displaying a personal icon when the first user moves to the second user's personal community will now be described.

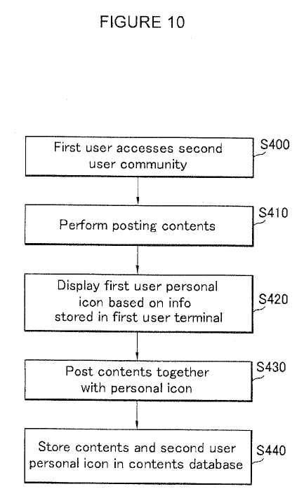

FIG. 10 shows an exemplified sequential process for displaying a personal icon when the user moves.

As described above, when the first user, having logged in to the system and received personal icons at the user's terminal, accesses the second user's personal community and posts a reply to the contents posted by the second user to thus perform a contents-related action in steps S400 and S410, the icon transmission module 123c of the first community server 120 takes data files from the icon providing server 110 based on the path information of personal icons stored in the user terminal 300, and displays them in cooperation with the reply posted by the first user in step S420. In this instance, it displays a representative icon from among the personal icons. In this case, a modifiable key is displayed on the side of the representative icon so that the user may display all the personal icons possessed by the user and select a predetermined personal icon when the user operates the key. Accordingly, when the first user selects the predetermined personal icon, the displayed representative icon is deleted, and the selected personal icon is displayed. Here, the first community server 120 may initially take all the personal icon files of the first user from the icon providing server 110 and may display the first user's personal icon in relation to the reply, and differing from this, it may initially take the first user's representative icon from the icon providing server 110 and display it in cooperation with the reply, and when the user selects the key, it may take the first user's residual personal icon files from the icon providing server 110 and display the same.

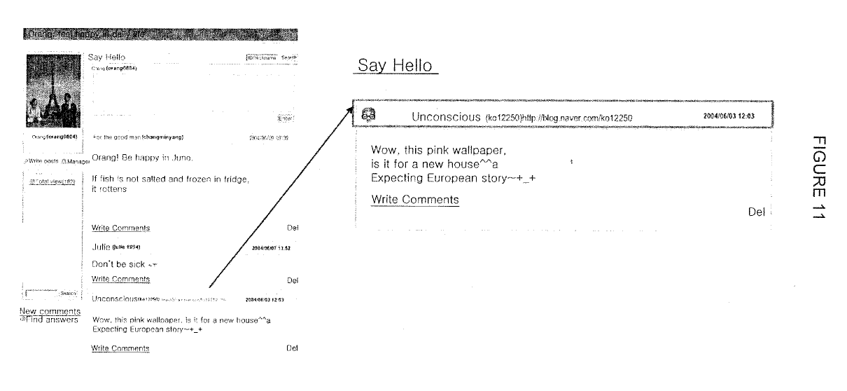

Next, when the first user requests to post contents such as a reply, the icon transmission module 123c displays the contents provided by the first user on the corresponding page. FIG. 11 shows an exemplified case for displaying a personal icon when a user, having accessed a blog, posts contents. The icon transmission module 123c stores the posted contents in the contents database 124 corresponding to the second user's personal community in step S430, and in this instance, it stores the first user's personal icon (e.g., an icon data file) corresponding to the contents so that the first user's personal icon for the contents may be displayed in step S440 when the contents of the second user's personal community are provided. In particular, the second community server 130 can quickly and easily display personal icons of corresponding users for respective contents without performing communication with the icon providing server 110, by storing the first user's personal icon in the contents database 124 together with corresponding contents.

In addition to the action of posting contents as described above, when the first user accesses the second user's community to leave a visit message or form a predetermined relationship such as “neighbor,” the icon transmission module 123c stores a personal icon together with an identification code of the first user in the relationship database 125. Therefore, when the second user's personal community service page is provided, information of the first users or information of the first users that have formed a predetermined relationship is provided together with a personal icon.

As described, when the first user accesses the second user's community to post contents or leave a visit message, or performs a predetermined action of forming a predetermined relationship and stores corresponding results, the first user's personal icon information is stored together with them so that the personal icon may be displayed together with results of the first users without additional communication with the icon providing server when the second user's community-related information page is displayed.

Also, since the personal icon has a single-layer structure and the file capacity is small, results caused by a plurality of actions of the user can be displayed at a plurality of positions on the service page such as a web page together with the personal icon.

According to the above-described process, information on the personal icons is stored in the terminals of logged-in users in the personal community such as a blog, and hence, the users' personal icons can be easily displayed by using the information when the user moves to another user's personal community and performs a predetermined action.

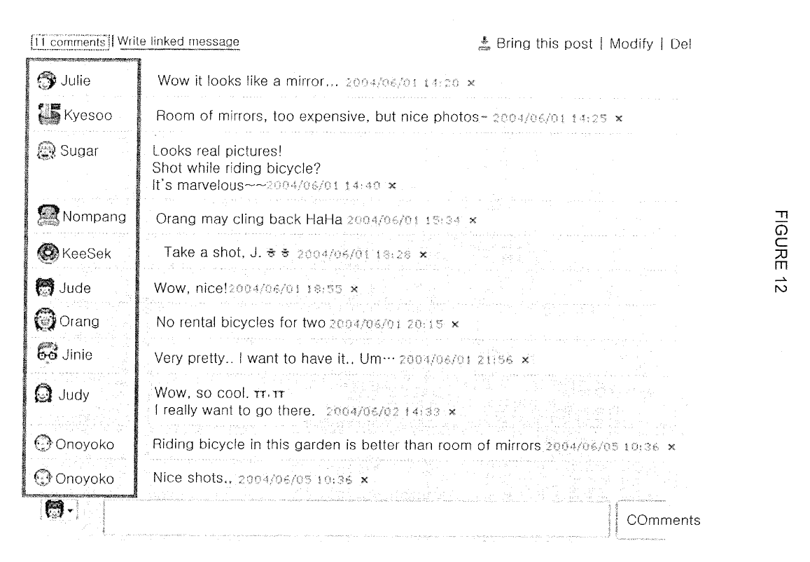

The method for displaying the personal icon can be applied to shared communities such as cafés in a like manner. For example, when a user registered as a member to a café logs in, information on the personal icons is provided to the user's terminal so that the user can easily display the personal icon by using the information stored in the terminal when the user performs an action such as posting contents on a bulletin board. Also, it is possible to store the user's personal icon corresponding to the contents when the user posts contents on the bulletin board, so that the personal icon of the user having posted corresponding contents can be displayed on the bulletin board together with the contents. FIG. 12 shows an exemplified case of displaying a personal icon on a bulletin board such as that of a café.

Since a person skilled in the art can display the icon in a shared community based on the above-described embodiment, details of operations between respective components of the second community server 130 and the icon providing server 110 will be omitted.

When a predetermined event is performed in a shared community (or a personal community) and users having won the event are displayed in the shared community, the personal icon together with identification codes (e.g., IDs) of the users having won the event is stored. For example, when a default value established from a community generation date has expired, an event for allowing the users who accessed communities and performed predetermined actions to have won the event is performed, and the personal icon together with the user ID is stored. Therefore, it is easy to display the personal icons together with information on the users who have won the event to users accessing the community without additional communication with the icon providing server 110. Types of events may include an event for providing compensation to a user having registered as a member when the number of members has satisfied a predetermined value, an event for providing compensation to a visitor when the number of visitors to the community has reached a predetermined value, and an event for providing compensation to a visitor having posted articles when the number of articles registered to the community has reached a predetermined value.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

According to the present invention, personal icons can be easily displayed at any position on the Internet by using the personal icons having a single-layer structure.

Also, personal icons for identifying users can be provided in cooperation with the users' movement at any position on the Internet, and hence, features or sensitivity appropriate to individuals can be easily expressed at any position on the Internet where various services are provided.

Further, an additional communication process with an icon providing server can be eliminated by storing users' personal icons in user terminals and then displaying the personal icons by use of stored information, and hence, the personal icons can be provided quickly and easily.

In addition, when the user performs a predetermined action such as posting contents in a community service such as a café or a blog, the personal icon is stored together with results (contents) caused by the action So that the contents and personal icon are quickly displayed based on the stored personal icons when providing community-related information.

What is claimed is:

1. A method for providing a personal icon by using an icon providing server and a service providing server in a system connected to a user terminal through a network, the method comprising:
a) the icon providing server providing personal icons to users according to requests by the users who are accessed through the network, and storing a provided history;
b) the service providing server receiving information on the personal icons received by the user from the icon providing server when the user is accessed;
c) the service providing server transmitting information on collected personal icons to the user terminal to store the information in the user terminal; and
d) the service providing server generating a service page for displaying a personal icon of the user on at least one position by using the information stored in the user terminal and providing the service page.

2. A method for providing a personal icon by using an icon providing server and a community server connected to a user terminal through a network, the icon providing server storing and controlling information on personal icons provided to users, the method comprising:
a) the community server receiving information on personal icons received by a first user from the icon providing server when the first user is accessed through the network;
b) the community server transmitting information on collected personal icons to the first user's terminal to store the information in the first user's terminal;
c) the community server displaying the first user's personal icon on the network by using the information stored in the first user terminal; and
d) the community server storing results caused by an action of the second user and personal icon information of the second user corresponding to the first user's community when the second user accesses the first user's community through the network and performs a predetermined action.

3. The method of claim 2, wherein the community server in d) receives a data file on the personal icon of the second user from the icon providing server and stores the data file together with the second user's results.

4. The method of claim 3, wherein a personal icon selected from among a plurality of personal icons is established to be a representative icon, and the representative icon is displayed in cooperation with the identification code when the plural personal icons are provided to the user.

5. The method of claim 1 or 2, wherein the personal icon is displayed in cooperation with an identification code assigned to the user when the personal icon is displayed.

6. The method of claim 1 or 2, wherein information stored in the user terminal is an identification code of personal icons provided to the user.

7. The method of claim 1 or 2, wherein information stored in the user terminal is path information on positions where personal icons provided to the user are stored.

8. The method of claim 1 or 2, wherein information stored in the user terminal is a data file of personal icons provided to the user.

9. The method of claim 1 or 2, wherein the personal icon includes a default personal icon, and a modified personal icon generated by modifying a predetermined component of the default personal icon or adding a new component thereto.

10. The method of claim 1 or 2, wherein the personal icon has a single-layer structure.

11. A system for providing a personal icon, the system connected to a user terminal through a network, the system comprising:
a provision history database for storing information on personal icons assigned to respective users;
an icon collector for collecting information on the personal icons assigned to the user from the database when the user is accessed through the network;
an icon transmitter for transmitting information on the collected personal icons to the user terminal to store the information in the user terminal; and
an icon display for displaying a personal icon of the user on the network by using the information stored in the terminal.

12. The system of claim 1, wherein the icon display displays the personal icon in cooperation with the user's identification code.

13. A service providing server for providing a predetermined service to users accessed through a network, the server being connected to a user terminal and an icon providing server through the network, the service providing server comprising:
a registration database for storing user information;
a certifier for performing a log-in process to the user accessed through the network based on the information stored in the registration database;
an icon collector for collecting information on the personal icons corresponding to an identification code of the logged-in user from the icon providing server;
an icon transmitter for transmitting information on the collected personal icons to the user terminal to store the information in the user terminal;
an icon display for displaying a personal icon corresponding to the user's identification code on the network by using the information stored in the terminal; and
a service provider for providing services including a service for posting contents of the logged-in user.

14. The service providing server of claim 13, wherein the service providing server further comprises a database for storing contents generated when the user uses the service, and
the service provider stores the displayed personal icon of the user together with the contents of the user in the database and controls the same.

15. The service providing server of claim 13, wherein the service providing server provides a community service.

16. In a system connected to a user terminal and a service providing server through a network, a system for providing a personal icon, comprising:
an icon database for storing information related to personal icons;
an icon provider for providing information on the personal icons of the icon database to users accessed through the network, and assigning a predetermined personal icon to the user from among the provided personal icons according to the user's selection; and
a provision history database for storing information on the personal icon assigned to the user, and
wherein the icon provider transmits information on the personal icon to the user's terminal to store the information in the user terminal.

17. The system of claim 16, wherein the icon provider transmits information on the personal icon assigned to the user accessed through the network to the service providing server according to a request of the service providing server.
